(19) United States
(12) Patent Application Publication
(10) Pub. No.: US 2011/0277381 A1
(43) Pub. Date: Nov. 17, 2011

(54) BIO-DEGRADABLE POT FOR PRE-PLANTED BULBS

(75) Inventors: Joep Paternostre, Waynesboro, VA (US); Martinus Verlouw, Stuarts Draft, VA (US)

(73) Assignee: Bloomaker USA, Inc., Waynesboro, VA (US)

(21) Appl. No.: 13/105,308

(22) Filed: May 11, 2011

Related U.S. Application Data
(60) Provisional application No. 61/334,404, filed on May 13, 2010.

(51) Int. Cl. A01G 9/02

(52) U.S. Cl. 47/66.7; 47/73; 47/74

(57) ABSTRACT

A biodegradable container for planting bulbs may include a plurality of layers with pre-positioned bulbs for each layer. Each layer may be a different species or type of bulb so that the depth of the specific bulb is appropriate for each type of bulb when the container is “planted” in the ground. The container may include a partition to separate each layer, and the partition may hold the layer of bulbs in relative position at a suitable depth throughout shipping of the container and eventual planting of the container. The container may include soil that holds the different bulbs in relative position, with or without the partition. The container permits easy planting of a variety of flowers by a consumer without inordinate labor or much concern about depth levels, since the container automatically establishes a suitable depth for each respective type of bulb therein, once the container is properly positioned in the ground.

### CROSS REFERENCE TO RELATED APPLICATIONS

This application claims the benefit of U.S. Provisional Application No. 61/334,404, entitled BIODEGRADABLE POT FOR PRE-PLANTED BULBS, filed May 13, 2010, which application is incorporated herein by reference in its entirety.

### BACKGROUND

1.0 Field of the Invention

This invention relates generally to a biodegradable flower pot designed for planting multiple layers of flower bulbs in the ground in a single container and, more particularly, to a system and method for planting a variety of flowers that may have different flowering times and depths of planting in one container.

2.0 Related Art

The number of consumers purchasing bulbs in the fall, for example, and planting them by hand has decreased dramatically over the last about 5-10 years, or so. This may be due, in part, to the amount of work it takes to plant individual bulbs and partly because of disappointment in earlier plantings. Moreover, creating a visually appealing flower garden with a mixture of different flowers may be more effort than some people care to undertake. In addition, many consumers fail to allow for proper depth of varying bulb species, resulting in a failure of the bulb(s) to thrive.

### SUMMARY OF THE INVENTION

The above issues and problems are resolved by the apparatus and method provided by the invention so that a consumer can increase their success in the planting of various types of flowering bulb species, thus producing flowers for a longer duration of time from a single container. Moreover, a consumer may be more motivated to plant flower bulbs when multiple bulbs may be “planted” with one container and one hole.

In one aspect, an apparatus for planting bulbs is provided that includes a container having soil therein and a plurality of bulbs therein, the plurality of bulbs including different varieties of bulbs, the plurality of bulbs arranged within the container at a plurality of levels with a different variety of the plurality of bulbs on each level, the container configured to be plantable in the ground so that a suitable depth for each different variety of bulb therein is achieved thereby promoting successful blooming for each different variety.

In another aspect, an apparatus for planting bulbs may be provided that includes a biodegradable container having soil therein and a plurality of different types of plant bulbs therein, the plurality of different type plant bulbs arranged within the container at a plurality of levels with at least one different type of plant bulb on each level, the container configured to be plantable in the ground so that a suitable depth for each different type of bulb therein is achieved, thereby promoting successful blooming for each different type.

In yet another aspect, a method for planting bulbs is provided that includes providing a biodegradable container having soil therein and a plurality of different type of flower bulbs therein, the plurality of different types of plant bulbs arranged within the container at a plurality of levels with at least one different type of plant bulb on each level, the container configured to be plantable in the ground so that a suitable depth for each different type of bulb therein is achieved, thereby promoting successful blooming for each different type and shipping the biodegradable container for eventual planting, and shipping the biodegradable container for eventual planting.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIG. 1 is a partial cross-sectional perspective view of an embodiment of a container for planting flower bulbs, configured according to principles of the invention;

FIGS. 2A, 2B and 2C illustrate the container of FIG. 1 or FIG. 3, showing a succession of various bloom times, according to principles of the invention; and

FIG. 3 is another partial cross-sectional perspective view of an embodiment of a container for planting flower bulbs, configured accounting to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

The apparatus and method of the invention may include providing individuals with an ease in which to plant a larger variety of flowering bulbs in a single “planting” without the concern of proper depths with regard to varying bloom times. In this way, the consumer's ability to successfully harvest a larger variety of flowers at spring-time is greatly increased, along with a more convenient approach to planting bulbs, in general. By making it easier and more pleasurable to plant flower bulbs, consumers may be motivated to plant flowers.

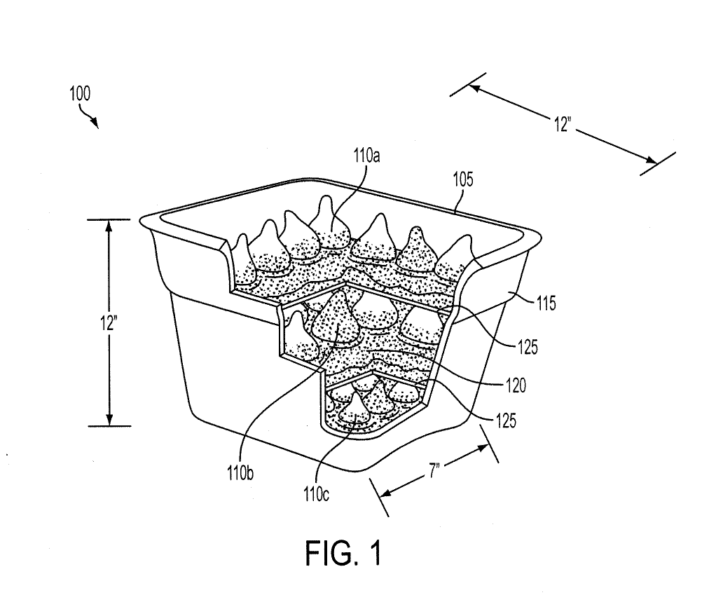

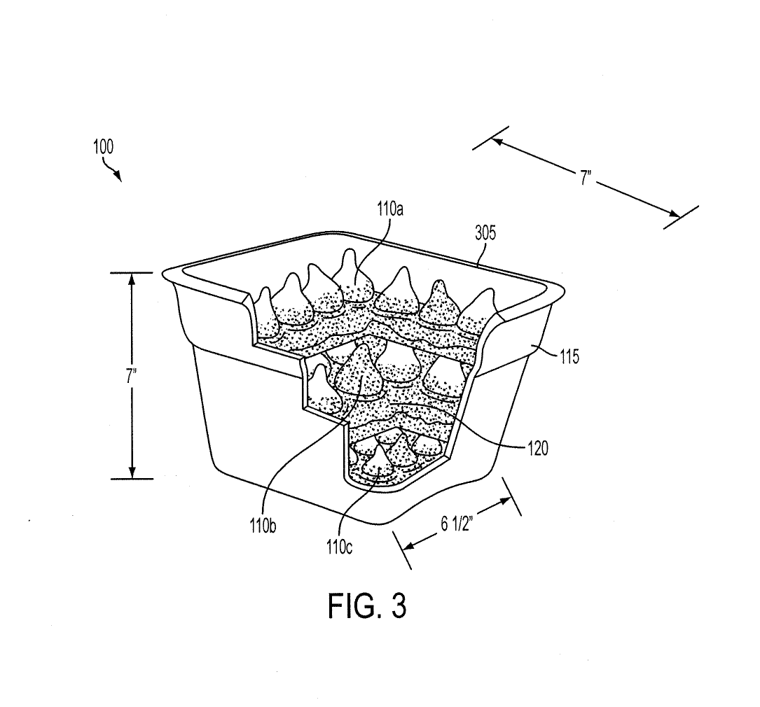

FIG. 1 is a partial cross-sectional perspective view of an embodiment of a container 105 comprising biodegradable material such as wood fiber, manure, and/or peat moss, for example, and configured to provide multiple bulb depth levels, such as the three levels as shown but may contain as few as two levels or four or more levels, and generally denoted by reference numeral 100. Alternate biodegradable compositions may include one or more of: newspaper, cornstarch and/or plant fibers, in whole or in part. The dimensions shown in FIG. 1 are exemplary, and may include other dimensions, as different sized containers 105 may be provided for different applications, such as shown in relation to FIG. 3, for example. The dimensions shown in FIG. 1 may be used as alternative exemplary dimensions for FIG. 3.

In one aspect, the container 105 may be configured to include one or more ledges or protrusions 115 in one or more sides of the container 105 with which to support a shelf 125 that may be biodegradable, at least in part, in order to partition the various levels of bulbs 110a, 110b and 110c in accordance with bulb characteristics, such as required planting depth, their respective blooming times, or the like. In some applications, the shelf 125 may also be impregnated with fertilizers or growth enhancers for the bulbs related to a particular level. In one aspect, the shelf may comprise a partition and may and contain an adhesive with which to adhere to the walls of container 105 or protrusions 115. The protrusions 115 may position a shelf 125 to keep the various layers in place and ensure that the bulbs maintain a separate quarter from neighboring layers. Alternatively, the protrusions 115 may be notches configured to support the shelf 125. In some applications, the shelf 125 may comprise a biodegradable paper-like material, perhaps with perforations, to hold the bulbs in place, yet permit water to enter each level. The paper-like shelf may be constructed with adhesive to adhere the paper-like material to the inner surfaces of the container 105.

In another aspect, the container 105 may contain potting soil 120, possibly with a corrected PH and slow release fertilizer. The potting soil may substantially envelop or cover the bulbs at each layer. The container 105 may be made from biodegradable material, in whole or in part, that may degrade to compost completely in the ground in about four to six months after planting, for example. The potting soil 120 may aid in holding the bulbs 110a, 110b, 110c substantially at predetermined relative positions from one another, and may be employed without use of a partition 125. The bulbs 110a may represent one type of bulb such as a first species or variety of flower bulb, bulbs 110b may represent a second type of flower bulb such as a second species or variety of flower bulb, and bulbs 110c may represent a third type of flower bulb such as a third type of species or variety of flower bulb.

When placed or planted in the ground, the biodegradable container 105 may be configured to permit a plurality of layers of bulbs to be placed and maintained at a suitable layer so that each bulb in each layer is maintained at a suitable depth and the layers of bulbs sprout and bloom at their appropriate time, and as appropriate for their type and depth.

For example, assuming an exemplary temperate zone, after setting or “planting” the container 105 of bulbs into a hole in the ground, with the top of the container 105 proximate the surface or slightly lower than the surrounding ground, a top layer of bulbs 110a within the container 105 may sprout and surface as early as March and may be positioned at a depth of approximately 4½ inches below the top of the container, as would be appropriate for such species as Crocus and Cinodoxa, for example. A second layer of bulbs 110b, positioned by and within the container at a depth of approximately 7 inches below the top edge of the container 105 may surface in late March or even April and may include Muscari or Scilla as well as Tulips and some Daffodils, for example. The latest flowering bulbs 110c positioned at a depth of approximately 11 inches below the top of the container 105 may surface by mid-April and may include Alliums and late Daffodils, for example. By placing/planting the container 105 in a selected and suitable location, e.g., adequate sun, the bulbs at each layer are automatically “planted” at a suitably correct depth for the bulb type, since the bulbs are pre-positioned and held in relative position within the container 105, arrangement of the bulbs may be based on the type of bulb and/or the bulb characteristics. Of course, any type of suitable species may be employed, as desired.

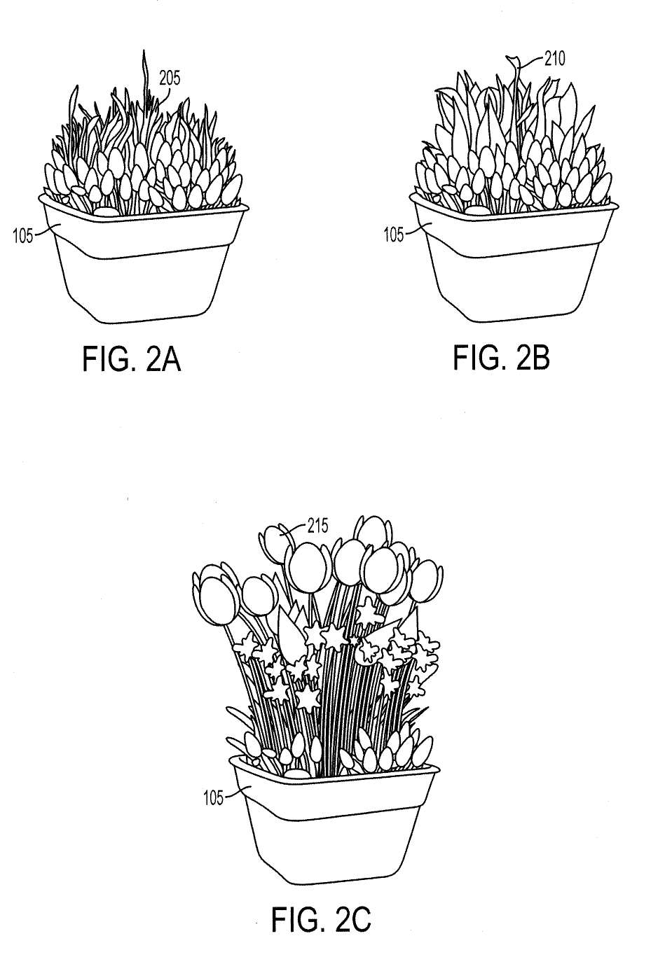

FIGS. 2A, 2B and 2C illustrate the container of FIG. 1 or FIG. 3, showing a succession of various bloom times, with FIG. 2A representing the earliest set of blooms 205 of a first type of flower, FIG. 2B the second set of blooms 210 of a second type of flower and ending at FIG. 2C for the latest set of blooms 215 of a third type of flower, as described in relation to FIG. 1 above.

FIG. 3 illustrates a container similar to the container of FIG. 1 or FIG. 3, showing exemplary dimensions and an embodiment of container 305 using potting soil 120 to maintain the multiple layers of bulb species without utilizing any shelf. The potting soil may also maintain the bulbs 120 spaced apart vertically and horizontally from one another. The potting soil 120 may substantially envelop or cover the bulbs at each layer. The potting soil 120 may be firmly packed within the container 105, 305 to better assure that the relative positions of the bulbs 120 are substantially maintained during normal shipment.

By providing a container 105, 305 with pre-positioned bulbs within the container 105, 305, a consumer may easily “plant” the container 105, 305 in a chosen location and automatically have the various types of bulbs of the various levels automatically set at an appropriate depth so that the bulbs may bloom more successfully and consistently compared with manual planting of individual bulbs. Moreover, the container 105, 305 may provide for a simpler and more efficient manner for shipping a suit of bulbs and may provide for an attractive way for a consumer to plant a plurality of bulbs that may include different species or varieties, and may have different growth rates and depth requirements. Since the container 105, 305 also includes appropriate potting soil for the type of bulbs, the container 105, 305 may be planted in areas that normally would not support bulb planting, such as rocky or sandy soil, for example.

It is also contemplated that a particular level within a container might comprise a different type of soil mixture, as compared with another layer, if a type of bulb for that layer necessitates such a differing soil. Moreover, the container 105, 305 may be configured generally as a rectangular container, a square container, a circular container, or any other suitable configuration.

The container 105, 305 may be configured of sufficient strength to be packed atop one another on pallets, for example, for shipping and storage purposes. In one aspect, when a container is sized about 12″×12″×7″, a pallet may contain 6 layers with 120 containers per pallet. However, other sizes of containers and packing counts are contemplated also. A container may be wrapped with instructions on how to use the container and other related planting and plant information.

In one aspect, the bulbs 110a, b and c may be planted in multiple layers to get different flowering times and/or to fit more bulbs 110a, b and c into the container 105, 305, perhaps a quantity of 50 to 70 bulbs, for example, depending on bulb sizes.

The bulbs 110a, b and c may be selected to certain standards, as appropriate, such as flowering times, i.e., from early to late, with early flowering on a top layer and later flowering on a lower layer(s); flowering heights, i.e., early flowers are short, later flowers are taller; and/or naturalizing bulbs only (i.e., year after year).

The potting soil may employ corrected Ph and may contain slow release fertilizers. Typically, the potting soil may be very dry so that early growth of the bulbs does not occur, or at least minimized. The soil may also contain a wetting agent.

In some applications, the layers formed within the container 105, 305 may have the soil in a specific layer tailored to a specification for the bulbs in that layer different from another layer.

Before or after the container is planted or placed in a selected ground location, the container 105, 305 may be watered.

The biodegradable apparatus constructed and implemented according to the principles herein may significantly increase consumer enthusiasm for planting flowers. The method of using the biodegradable container is simple and increases the likelihood of successful flower gardening.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. An apparatus for planting bulbs, comprising:
a container having soil therein and a plurality of bulbs therein, the plurality of bulbs including different varieties of bulbs, the plurality of bulbs arranged within the container at a plurality of levels with a different variety of the plurality of bulbs at each level, the container configured to be plantable in the ground so that a suitable depth for each different variety of bulb therein is achieved thereby promoting successful blooming for each different variety.

2. The apparatus of claim 1, wherein the container comprises a biodegradable material, at least in part.

3. The apparatus of claim 1, wherein the plurality of bulbs are separated by a partition.

4. The apparatus of claim 3, wherein the partition holds a plurality of bulbs in position at one of the plurality of levels.

5. The apparatus of claim 3, wherein the partition holds a subset of the plurality of bulbs in position relative to another subset of the plurality of bulbs.

6. The apparatus of claim 3, wherein the partition is biodegradable, at least in part.

7. The apparatus of claim 1, wherein the different varieties of bulbs are held in position from one another at least in part by the soil.

8. The apparatus of claim 1, wherein the container has at least one side wall and further comprising at least one protrusion in the side wall for holding at least one partition in place to create the plurality of levels.

9. The apparatus of claim 1, wherein the container has a plurality of side walls and a bottom.

10. The apparatus of claim 1, wherein the container is generally circular in shape.

11. An apparatus for planting bulbs, comprising:
a biodegradable container having soil therein and a plurality of different types of plant bulbs therein, the plurality of different types of plant bulbs arranged within the container at a plurality of levels with at least one different type of plant bulb on each level, the container configured to be plantable in the ground so that a suitable depth for each different type of bulb therein is achieved, thereby promoting successful blooming for each different type.

12. The apparatus of claim 11, wherein the container includes fertilizer.

13. The apparatus of claim 11, wherein the biodegradable container is configured with at least one protrusion to support a partition to form the plurality of levels.

14. The apparatus of claim 13, further comprising the partition.

15. The apparatus of claim 14, wherein the partition is biodegradable, at least in part, and comprises a shelf.

16. The apparatus of claim 11, further comprising a partition that holds the plurality of different types of plant bulbs in position within at least one of the plurality of levels, the levels configured to be at a suitable depth for each respective different type of plant bulbs when the biodegradable container is planted.

17. The apparatus of claim 11, wherein the soil aids in holding the plurality of different types of plant bulbs substantially in relative position to one another.

18. The apparatus of claim 11, wherein the biodegradable container is of sufficient strength to be stacked upon at least one other biodegradable container for shipping.

19. A method for planting bulbs, the steps comprising:
providing a biodegradable container having soil therein and a plurality of different types of plant bulbs therein, the plurality of different types of plant bulbs arranged within the container at a plurality of levels with at least one different type of plant bulb on each level, the container configured to be plantable in the ground so that a suitable depth for each different type of plant bulb therein is achieved, thereby promoting successful blooming for each different type of plant bulb; and
shipping the biodegradable container for eventual planting.

20. The method of claim 19, further comprising forming the plurality of levels with at least one partition within the container.

21. The method of claim 19, wherein the different types of plant bulbs includes a different species or a different variety.

22. The apparatus of claim 2, wherein the biodegradable material comprises manure.

23. The method of claim 19, wherein the biodegradable container comprises a biodegradable container made from manure.

24. The method of claim 11, wherein the biodegradable container comprises a biodegradable container made from manure.
